(19) United States
(12) Patent Application Publication
(10) Pub. No.: US 2020/0288738 A1
(43) Pub. Date: Sep. 17, 2020

(54) METHODS OF PREPARING ANTI-AGGLOMERATION YOGURT-BASED PRODUCTS FOR USE AS AEROSOL FOOD PRODUCTS

(71) Applicant: Whipped Yogurt, Inc., Malibu, CA (US)

(72) Inventors: John Joseph Yasosky, Maple Grove, MN (US); George William Murgatroyd, III, Malibu, CA (US)

(73) Assignee: Whipped Yogurt, Inc., Malibu, CA (US)

(21) Appl. No.: 16/355,580

(22) Filed: Mar. 15, 2019

(51) Int. Cl. A23C 9/13; A23C 9/123; A23C 3/03; B65B 31/00

(52) U.S. Cl. CPC A23C 9/1307; A23C 9/123; A23C 2270/10; B65B 31/003; A23C 3/03

(57) ABSTRACT

The present disclosure is related to a method and product of preparing an anti-agglomeration yogurt-based product for use in an aerosol container, comprising: creating a suspension comprised of at least one dairy ingredient and water, pasteurizing the suspension, cooling the suspension to a temperature range to enable culture activity, inoculating the suspension with a culture of yogurt-forming bacteria, homogenizing the suspension, and packaging the suspension.

### FIELD OF USE

The present disclosure relates generally to food products and their methods of preparation. More particularly, the present disclosure relates to methods of preparation for cultured yogurt-based products for use as aerosol food products.

### BACKGROUND

The process for making yogurt is well known. Generally, milk with a modified composition is first heated, pasteurized, and homogenized. This milk is then inoculated with bacteria cultures Lactobacillus bulgaricus and Streptococcus thermophilues and incubated at a specific temperature to maximize the activity of the bacteria. The bacteria convert the milk sugar to lactic acid, which thickens the milk, creating what is known as yogurt. The lactic acid level is used to determine when the yogurt is ready. A value of at least 0.9% titratable acidity is the current standard for yogurt manufacture in the United States, as set forth in 21 CFR 131.200. Once the yogurt reaches the desired acidity level, it is cooled. Additives, such as artificial colors and flavors, sweeteners, preservatives, emulsifiers, and stabilizers, can be added to the final product. Inclusion of stabilizers, such as food starch, gelatin, locust-bean gum, and other types of gum, may improve the consistency and shelf stability of the yogurt.

This current process, however, prevents yogurt from being packaged for use as an aerosol food product. Many yogurts are too viscous to be used as an aerated product. And, lower viscosity yogurt products that are able to be used as an aerosol have serious stability issues. Specifically, once cooled and stored, the fat and whey begin to physically separate from the yogurt, with the fat rising to the top. Agglomeration refers to the naturally-occurring process of solid particles sticking to each other. Unless the yogurt is consistently mixed, agglomeration of the fat continues unimpeded—resulting in a layer of fat that sits on top of the yogurt. This agglomeration eventually results in both the fat and yogurt existing as two separate, solid masses. When stored in an aerosol container, the agglomerated fat and separated layers prevent the yogurt from being dispensed from the aerosol container, regardless of attempts to re-mix the separated layers through vigorous shaking of the container. Previous attempts to resolve this problem have only resulted in a yogurt product that does not comply with general safety standards (such as those set forth in 21 CFR 131.200), has a very short shelf life, or has anti-agglomeration characteristics that are extremely short-lived, if at all.

Thus, what is needed are methods of preparation for a yogurt-based product that can be stored and used as an aerosol food product. Such methods will minimize or inhibit the formation of separated layers that otherwise occur when stored. This provides the benefit of a longer shelf-life for the product, while complying with food safety requirements, appealing to the consumer, and retaining the properties that allow for the product to be dispensed from an aerosol container.

### SUMMARY

The following presents a simplified overview of example embodiments in order to provide a basic understanding of some aspects of the invention. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

In accordance with the embodiments disclosed herein, the present disclosure is related to a method of preparing an anti-agglomeration yogurt-based product for use in an aerosol container, comprising: creating a suspension comprised of at least one dairy ingredient and water; pasteurizing the suspension; cooling the suspension to a temperature range to enable culture activity; inoculating the suspension with a culture of yogurt-forming bacteria; homogenizing the suspension; and packaging the suspension, such as in a pressure dispensing aerosol container. Methods for preparation of the product may also comprise after inoculation, when the suspension pH range is between 4.0 and 4.4, mixing a cream into the suspension, and also adding lactic acid after mixing the cream into the suspension to maintain a pH range between 4.0 and 4.6. Other embodiments further comprise, before the pasteurization of the suspension, heating the suspension to a temperature range between 100 and 110 degrees Fahrenheit and homogenizing the suspension.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure. As it will be realized, the present disclosure is capable of other different embodiments and its several details are capable of modifications in various obvious embodiments all without departing from, or limiting, the scope herein.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a functional flow diagram generally illustrating an embodiment of a method of preparation for an anti-agglomeration yogurt-based product for use as an aerosol food product.

FIG. 2 is a functional diagram generally illustrating an embodiment of an anti-agglomeration yogurt-based product for use as an aerosol food product.

### DETAILED DESCRIPTION OF THE ILLUSTRATIVE EMBODIMENTS

Before the present methods and systems are disclosed and described, it is to be understood that the systems and methods are not limited to specific methods, specific components, or to particular implementations. It is also to be understood that the terminology used herein is for the purpose of describing particular embodiments only and is not intended to be limiting. Various embodiments are described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments. While not intending to be bound by only the embodiments disclosed herein, the embodiments below allow for the successful preparation of an anti-agglomeration yogurt for use as an aerosol food product.

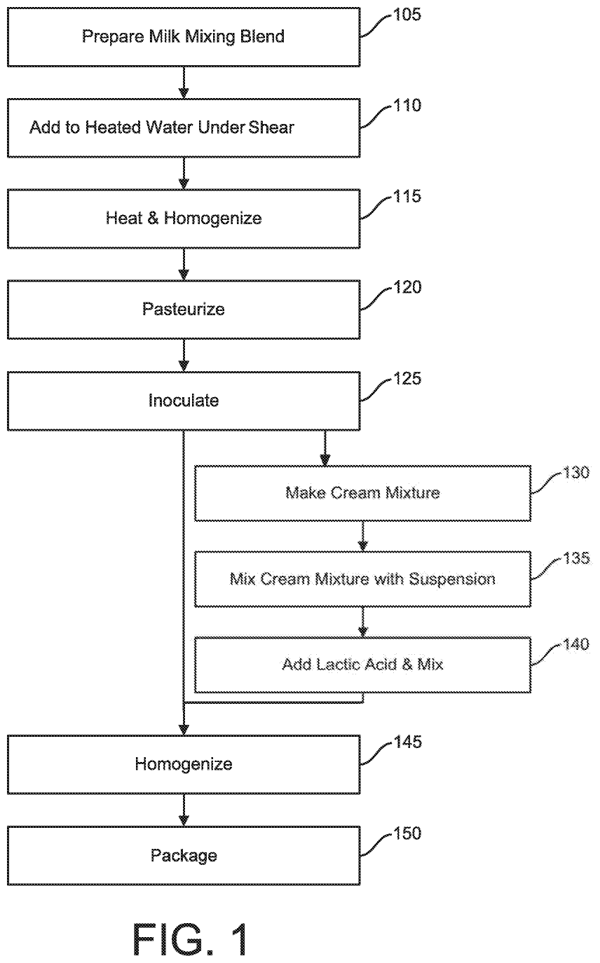

FIG. 1 is a functional flow diagram generally illustrating an embodiment of a method of preparation for an anti-agglomeration yogurt-based product for use as an aerosol food product. As shown in FIG. 1, in one embodiment, the method begins with the preparation 105 of a milk mixing blend. A milk mixing blend may comprise of a dairy ingredient with one or more optional ingredients, such as hydrocolloids and/or fiber sources. In another embodiment, the milk mixing blend may comprise only of a dairy ingredient. The milk mixing blend is mixed 110 in a shear mixer, or a mixer with similar mixing capabilities, with water that has been heated to approximately 110° Fahrenheit (“F”). Mixing under shear creates a suspension, wherein the suspension is comprised of the milk mixing blend and water. The suspension is then heated and homogenized 115, with the suspension being heated to approximately 145° F. and homogenized at 2000 and 500 psi. Following homogenization, the suspension is heated again to approximately 178° F. At this point, the suspension may be weighed to determine the existing weight. A reason for weighing is so the weight of future ingredients can be modified based on this determined weight.

Following the first homogenization 115, the suspension is pasteurized 120. Pasteurization may be done by holding the suspension to approximately 180° F. for approximately thirty minutes. Alternatively, any method or process for pasteurizing may be used. The suspension is then cooled to an approximate temperature of 111° F., inoculated with a bacteria culture 125, and kept cool at an approximate temperature of 110° F. for four to five hours. Bacteria culture used in inoculation comprises Streptococcus thermophilus and Lactobacillus bulgaricus. Alternatively, any method or process for inoculation may be used. After inoculation 125, the suspension is heated to approximately 110° F. and homogenized 145 at 2000 and 500 psi. Following the second homogenization, the suspension is packaged 150.

In another embodiment, following inoculation 125, a cream mixture 130 is created by adding sodium citrate to pasteurized cream. The sodium citrate is mixed into the cream by gently stirring as the cream is warmed to approximately 110° F. The presence of sodium citrate helps stabilize cream emulsion. The purpose of gently stirring the cream mixture is to incorporate the sodium citrate into the cream without churning or adding air. In another embodiment, sodium citrate may be omitted completely from methods of preparing an anti-agglomeration yogurt-based product for use as an aerosol food product disclosed herein.

Once the suspension reaches a pH level of approximately 4.4, the heated cream mixture with a temperature of approximately 110° F. is mixed 135 with the suspension while preventing any incorporation of air. Any sweeteners and/or additives are added at this stage and mixed into the suspension/cream mixture. The cream in the suspension/cream mixture will have raised the pH of the overall suspension/cream mixture. To reduce pH levels to acceptable levels, lactic acid is added and mixed 140, making sure to prevent any incorporation of air. Afterwards, the suspension/cream mixture is heated to approximately 110° F. and homogenized 145 again at 2000 and 500 psi. Following the second homogenization, the suspension/cream mixture is packaged 150.

The final product resulting from the methods found in FIG. 1, now an anti-agglomeration yogurt-based product (referred throughout this disclosure as “Yogurt” for ease of reference), may be packaged into containers for temporary storage prior to inserting the Yogurt into aerosol containers. Alternatively, the Yogurt may be inserted directly into aerosol containers.

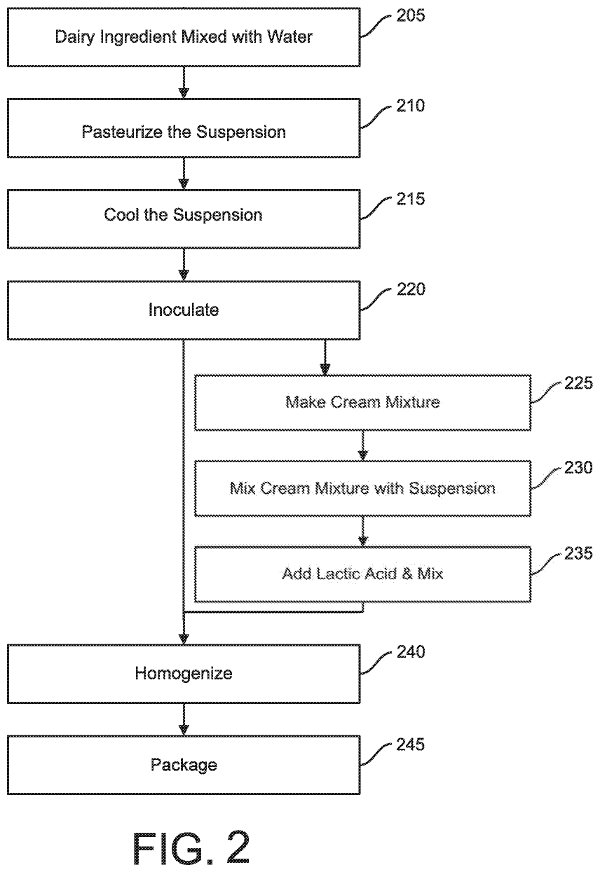

FIG. 2 is a functional diagram generally illustrating an embodiment of an anti-agglomeration yogurt-based product for use as an aerosol food product. As shown in FIG. 2, an anti-agglomeration yogurt-based product may comprise a suspension, wherein the suspension is created by mixing at least one dairy ingredient and water 205, and wherein the suspension is then pasteurized 210, cooled to a temperature range to enable culture activity 215, inoculated with a culture of yogurt-forming bacteria 220, homogenized 240, and finally packaged 245. In another embodiment, the product may also comprise a cream, wherein, before the suspension is homogenized 240, a cream mixture is prepared 225 and then mixed with the suspension 230. Lactic acid is added and mixed 235 into the product to reduce pH levels, following which the product is homogenized 240 and packaged 245.

The term “anti-agglomeration” used herein refers to the prevention of agglomeration of the fat once the final product is stored and cooled in aerosol container. Agglomeration of the fat leads to a layer of fat that sits on top of the yogurt, which eventually results in both the fat and yogurt existing as two separate, solid masses. Anti-agglomeration properties inhibit the formation of the two separate layers.

The anti-agglomeration yogurt-based products disclosed herein have good stability characteristics. The products are best stored at a temperature between 38° F. and 42° F., with an average shelf life of up to six months. When properly stored, the Yogurt retains a fluid viscosity, allowing it to be easily dispensable from an aerosol dispensing container.

Ingredients

Embodiments of dairy ingredients used in the preparation of the Yogurt comprise cream, milk, partially skimmed milk, or skim milk; which may each be used alone or in combination with other dairy ingredients. Other embodiments may comprise concentrated skim milk, nonfat dry milk, buttermilk, whey, lactose, lactalbumins, lactoglobulins, or whey modified by partial or complete removal of lactose and/or minerals.

Embodiments of optional ingredients that may be included in the milk mixing blend comprise various dry ingredients, such as hydrocolloids and fiber sources. Hydrocolloids are functional carbohydrates. Their purpose is to enhance shelf-life and quality. They may also be used to modify the viscosity and texture of the Yogurt. Additionally, hydrocolloids may have the following functions when used in the Yogurt: adhesion, binding, emulsification, stabilization, texture modification, and thickening. An embodiment of a hydrocolloid used in the preparation of the Yogurt comprises a dairyblend stabilizer, such as YG-AG (which is a blend of corn start, agar, and pectin). Other embodiments of hydrocolloids used comprise arabic gum, xanthan gum, guar gum, carageenans, locust bean gum, and other hydrocolloids that have thickening and emulsifying properties.

Embodiments of fiber sources comprise corn, oat, wood, pea, wheat, soy, or other fiber sources typically used in food systems. Fiber sources may serve as stabilizers and/or viscosifiers.

Emulsifiers such as Lecithin may be included in the milk mixing blend. Lecithin refers to any group of yellow-brownish fatty substances that occur in animal or plant tissues. Lecithins may be used for smoothing food textures, emulsifying, homogenizing liquid mixtures, and repelling sticking materials. Embodiments of lecithins comprise sunflower lecithins and soy lecithins. Other emulsifiers that may be used include, but are not limited to, polysorbate 60 or 80, mono and diglycerides, or other emulsifying or aerating emulsifiers typically used in food systems.

Embodiments of sweeteners comprise sugars (sucrose), beet or cane; invert sugar; brown sugar; fructose, corn syrup, molasses, and other commonly used sweeteners in the preparation of foods. Along with sweetening the Yogurt, sweeteners may also be used for water activity control and as a source of food for the culture.

One embodiment of cream comprises a heavy cream. Heavy cream is a cream that contains a milk fat content between 36 and 42 percent milk fat. Other embodiments may comprise cream with a higher or lower milk fat content. Embodiments of cream consist of either pasteurized cream or unpasteurized cream.

Timing of Homogenization

A significant, novel aspect of the methods and products disclosed herein is the timing of homogenization. Homogenization generally refers to the process of making a mixture of two mutually non-soluble liquids the same throughout. Here, specifically, it refers to the process of breaking down fat molecules in milk such that they stay integrated and suspended evenly in the milk rather than separating as cream and rising to the surface.

The methods herein disclose homogenization occurring at a critical stage in the preparation of the Yogurt: after fermentation. This is novel because all other previous methods and processes for preparing yogurt homogenized the yogurt prior to inoculation with bacteria cultures. Here, homogenizing after fermentation enables the anti-agglomerations properties of the Yogurt.

As shown in FIG. 1 above, an embodiment may contain double homogenization: the first homogenization takes place at the beginning—after the milk mixing blend and water have been mixed together. The second occurrence of homogenization takes place after the fermentation, addition of sweeteners, mixing with cream, and incorporation of lactic acid. However, the homogenization that occurs after fermentation is what is critical to the creation of an anti-agglomeration yogurt-based product. Thus, embodiments of the Yogurt may comprise of a single homogenization step, which occurs after fermentation.

Fermentation

Another novel aspect of the disclosure herein is the timing of the addition of sweetener, such as sugar, in the preparation of an anti-agglomeration yogurt-based product. The addition of sweetener prior to fermentation inhibits fermentation. Thus, in a preferred embodiment, the majority of the sweetener is added after fermentation.

Similarly, the timing of fermentation disclosed herein is critical to the preparation of the Yogurt. Fermentation refers to the chemical breakdown of a substance by bacteria, yeasts, or other microorganisms. In the general preparation of yogurt, the bacteria cultures Lactobacillus bulgaricus and Streptococcus thermophiles ferment lactose (milk sugar) to produce lactic acid. Here, the bacteria cultures ferment the suspension before the cream is added, as disclosed in the embodiment of FIG. 1. Attempts to ferment after the addition of cream result in a product that is significantly viscous and thus too difficult to work with. Thus, the timing of fermentation here enables the viscosity desired for both production and consumption.

Acidification

As stated above, the fermentation of the milk product results in the creation of lactic acid. Generally, upon reaching the desired pH level, fermentation is ceased by lowering the temperature. Federal U.S. government regulations require that the titratable acidity of yogurt be within safe parameters. Additionally, a yogurt product with a pH that is not within 4.0 and 4.6 tends to produce unwanted consequences, such as inconsistent flavor, consistency, and aroma. A deviation from such acceptable pH levels can also lead to a reduced shelf life or a product that is too bitter or tart.

Embodiments of the Yogurt do not require the addition of cream. However, when added, the cream automatically raises pH levels of the suspension. Thus, an additional significant, novel aspect of the methods and products disclosed herein is the incorporation of lactic acid when cream has been added. When the suspension pH level reaches 4.4, cream may be added to the suspension. The incorporation of lactic acid after the cream is added lowers pH levels back down to acceptable levels. This results in a yogurt-based product—comprised at least of unfermented cream and yogurt—that retains preferred consumer attributes and is safe for human consumption.

However, in other embodiments, the acidity for either the fermentation or final yogurt-based product disclosed herein may vary from the ranges provided, while still allowing for the methods of preparation of the Yogurt to be carried out effectively.

Temperature

Other novel aspects disclosed herein are the preferred temperature ranges and their effects on the preparation of the Yogurt. In one embodiment, after the cream and lactic acid have been added, the mixture is kept at a temperature that is above the melting point of milk fat. This allows for all sugar to be solubilized and keeps the cream in a liquid state. The temperature is also kept below pasteurization temperature—the temperature that enables the bacteria culture to thrive without being killed off—allowing for the culture to remain alive and active.

In another embodiment, temperatures may vary. For example, the temperature after addition of cream and lactic acid and prior to a second homogenization may be kept below the melting point of milk fat. If this is done, homogenization may still be carried out, but with increased difficulty and skewed results. In a separate embodiment, temperature may be higher than pasteurization temperature, allowing for the fat to remain in liquid state but also eliminating any live and active bacteria.

In other embodiments, temperatures for the heating, homogenizing, pasteurizing, cooling, and mixing steps disclosed herein may vary from the ranges provided, while still allowing for the methods of preparation of the Yogurt to be carried out effectively.

Pasteurization

In a preferred embodiment with double homogenization, pasteurization is carried out after the first homogenization and prior to inoculation of the milk product. However, other embodiments may comprise pasteurization occurring after fermentation but prior to the second homogenization. Yet in other embodiments, pasteurization may occur after both fermentation and the second homogenization.

Live/Active Culture

In one embodiment, a live and active culture exists in the finished product. This provides an added level of food safety: the high quantity of the live and active culture inhibits the growth of other bacteria that may be present or otherwise introduced into the product. In another embodiment, the finished product may exist without a live and active culture. There, the presence of any contaminants may be addressed by acidification, such as by the addition of lactic acid, or by pasteurization post-fermentation.

Packaging

In one embodiment, packaging the Yogurt directly into pressure dispensing aerosol containers is done by packaging it with a suitable propellant at a pressure of 145 PSI with a shake-time of fifteen (15) seconds. Standard propellant gases may be used, such as nitrous oxide. Other embodiments may comprise of combinations of varying pressures and shake-time, such as a pressure range from about 120 to 160 PSI and a shake time from about five to thirty seconds.

In other embodiments, packaging the Yogurt comprises the additional steps of pasteurizing again and refrigerating at a temperature that inhibits bacteria growth. Alternatively, packaging may comprise of ultra-pasteurizing the Yogurt at higher temperatures for a longer period of time when compared to general pasteurizing procedures, allowing for a longer shelf life. Packaging may also comprise of having the Yogurt undergo pressure at high temperatures and packaging it aseptically. This allows for a longer shelf life when compared to other embodiments, and may allow the Yogurt to be kept at room temperature.

Example 1 provides a list of ingredients and their weight percentage for one embodiment of an anti-agglomeration yogurt-based product for use as an aerosol food product.

### EXAMPLE 1

| Ingredient | Initial % | Final % |
|---|---|---|
| Water | 58.097 | 38.780 |
| Nonfat milk solids High heat | 9.948 | 6.640 |
| Sugar | 28.000 | 18.690 |
| TIC gum YG-AG | 1.498 | 1.000 |
| TIC Gum Gum arabic | 0.524 | 0.350 |
| Vanilla | 0.404 | 0.270 |
| Sunflower Lecithin | 0.749 | 0.500 |
| Z-Trim | 0.749 | 0.500 |
| Yo Flex Culture YF L902 | 0.022 | 0.015 |
| ABC Culture | 0.007 | 0.005 |
| Sodium Citrate | | 0.250 |
| 90% lactic acid | | 0.400 |
| Heavy Cream | | 32.600 |
| Total | 100.000 | 100.000 |

The column of Example 1 titled “Initial %” refers to the weight percentages of the ingredients up to the point of the addition of sodium citrate, lactic acid, and cream. The column titled “Final %” refers to the final weight percentage of the various ingredients once the final product has been cooled and packaged. As shown in Example 1, the Yogurt may comprise of the ingredients previously disclosed and additionally may comprise flavoring, such as the addition of vanilla flavoring. The Yogurt may also comprise a probiotic culture that is included in addition to the bacteria cultures Lactobacillus bulgaricus and Streptococcus thermophilus.

Testing

Testing Chart 1 below provides a summary of tests performed to determine the shelf life of ingredients found in the various embodiments of the Yogurt.

Testing Chart 1

| Product | Pkging | Month 1 | Month 2 | Month 3 | Month 4 | Month 5 | Month 6 | Month 8 | Month 10 |
|---|---|---|---|---|---|---|---|---|---|
| Vanilla | canned | | good | good | | | good | | |
| Direct Acid | | | flavor | flavor | | | flavor | | |
| | | | and | and | | | and | | |
| | | | whip | whip | | | whip | | |
| Chocolate | canned | | good | good | | | good | | |
| Direct Acid | | | flavor | flavor | | | flavor | | |
| | | | and | and | | | and | | |
| | | | whip | whip | | | whip | | |
| Vanilla | canned | | good | good | good | good | | good | |
| Direct Acid | | | flavor | flavor | flavor | flavor | | flavor | |
| (TIC gums) | | | and | and | and | and | | and | |
| | | | whip | whip | whip | whip | | whip | |
| Vanilla | canned | good | good | good | good | good | good | good | good |
| gum | | flavor | flavor | flavor | flavor | flavor | flavor | flavor | flavor |
| (xanthan) | | and | and | and | and | and | and | and | and |
| | | whip | whip | whip | whip | whip | whip | whip | whip |
| Vanilla | canned | good | good | good | good | good | good | good | good |
| gum (TIC) | | flavor | flavor | flavor | flavor | flavor | flavor | flavor | flavor |
| | | and | and | and | and | and | and | and | and |
| | | whip | whip | whip | whip | whip | whip | whip | whip |
| Chocolate | lab | no | no | no | | | no | | |
| (xanthan) | bottles | separation | separation | separation | | | separation | | |
| Chocolate | lab | no | no | no | | | no | | |
| (fiber) | bottles | separation | separation | separation | | | separation | | |
| Vanilla | Lab | no | slight | separation | | | | | |
| 33% cream | bottles, | separation | separation | in bottle, | | | | | |
| 2000 psi | two cans | | bottle, | can | | | | | |
| | | | can | whipped | | | | | |
| | | | whipped | well | | | | | |
| | | | well | | | | | | |
| Vanilla | Lab | no | slight | separation | | | | | |
| 40% cream | bottles, | separation | separation | in bottle, | | | | | |
| 2000 psi | two cans | | bottle, | can | | | | | |
| | | | can | whipped | | | | | |
| | | | whipped | well | | | | | |
| | | | well | | | | | | |
| Vanilla | Lab | some | separation | large | | | | | |
| 33% cream | bottles | separation | | separation | | | | | |
| 500 psi | | | | | | | | | |
| Vanilla | Lab | some | separation | large | | | | | |
| 40% cream | bottles | separation | | separation | | | | | |
| 500 psi | | | | | | | | | |

Testing Chart 2 below provides a summary of tests performed to determine the shelf life of various embodiments of the Yogurt (Formulas 1-3) prepared according to the methods disclosed herein.

Testing Chart 2

| | (Slow cooled in ice-bath stir) | | | | | |
|---|---|---|---|---|---|---|
| | Packaging | Month 2 | Month 3 | Month 4 | Month 5 | Month 6 |
| Test Formula 1 | lab bottles | ½″ | ½″ | ½″ | ½″ | Homogenized |
| homogenized | | separation | separation | separation | separation | samples had less |
| | | | | | | serum separation |
| | | | | | | vs. non |
| | | | | | | homogenized. |
| Test Formula 1 not | lab bottles | 1″ | 1.5″ | 1.5″ | 2.0″ | |
| homogenized | | separation | separation | separation | separation | |
| Test Formula 2 | lab bottles | ½″ | ½″ | ½″ | — | |
| homogenized | | separation | separation | separation | | |
| Test Formula 2 not | lab bottles | 1″ | 1.5″ | 1.5″ | 2.0″ | |
| homogenized | | separation | separation | separation | separation | |
| Test Formula 3 | lab bottles | ½″ | 1″ | 1″ | 1″ | |
| homogenized | | separation | separation | separation | separation | |
| Test Formula 3 not | lab bottles | 1″ | 1.5″ | 1.5″ | 2.0″ | |
| homogenized | | separation | separation | separation | separation | |

The final formula for an anti-agglomeration yogurt-based product prepared by the methods disclosed herein can vary significantly. This is because the final formula is dependent on the ingredients used. As a consumer product, aside from the necessary ingredients such as dairy products and the use of bacteria culture, a wide variety of ingredients are often used. Thus, while one embodiment may have the weight percentages found in Example 1, other embodiments may vary both in the ingredients used and the percentage weights of those ingredients. The novel element of the occurrence of homogenization after fermentation is what is essential. Thus, so long as methods incorporate this critical element and the product is kept stable, the methods yield an anti-agglomeration yogurt-based product that can be used as an aerosol food product.

Although the present disclosure is suitable for the preparation of an anti-agglomeration yogurt-based product, other embodiments may be used in connection with other food products such as fermented and unfermented soy, rice and nut milk products, and whipped toppings.

Throughout the specification and claims, percentages are by weight and temperatures in degrees Fahrenheit, unless otherwise indicated.

Still, other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure. As it will be realized, the present disclosure is capable of other different embodiments and its several details are capable of modifications in various obvious embodiments all without departing from, or limiting, the scope herein.

What is claimed is:

1. A method of preparing an anti-agglomeration yogurt-based product for use in an aerosol container, comprising:
creating a suspension comprised of at least one dairy ingredient and water;
pasteurizing the suspension;
cooling the suspension to a temperature range to enable culture activity;
inoculating the suspension with a culture of yogurt-forming bacteria;
homogenizing the suspension; and
packaging the suspension.

2. The method of claim 1, further comprising packaging the suspension in a pressure dispensing aerosol container.

3. The method of claim 1, wherein packaging the suspension comprises at least one of:
maintaining at temperatures that inhibit microbial growth, pasteurizing and maintaining at temperatures that inhibit microbial growth, ultra-pasteurizing and maintaining at temperatures that inhibit microbial growth, and processing aseptically.

4. The method of claim 1, wherein the homogenization is done at a pressure of 2000 psi.

5. The method of claim 1, further comprising, after inoculation, when the suspension pH range is between 4.0 and 4.4, mixing a cream into the suspension.

6. The method of claim 5, further comprising adding lactic acid after mixing the cream into the suspension to maintain a pH range between 4.0 and 4.6.

7. The method of claim 5, wherein the cream is either pasteurized or non-pasteurized.

8. The method of claim 1, further comprising, before the pasteurization, heating the suspension to a temperature range that facilitates homogenizing the suspension, and homogenizing the suspension.

9. The method of claim 2, further comprising packaging the suspension with a propellant in a pressure dispensing aerosol container at a pressure from about 120 to about 160 PSI and a shake-time from about 5 to 30 seconds.

10. The method of claim 1, wherein the at least one dairy ingredient comprises one or more of the following: cream, milk, partially skimmed milk, skim milk, nonfat dry milk, a milk fraction ingredient, and mixtures thereof.

11. The method of claim 1, further comprising mixing the at least one dairy ingredient with at least one optional ingredient prior to creating the suspension.

12. The method of claim 11, wherein the at least one optional ingredient comprises one or more of the following; a hydrocolloid, a fiber source, a lecithin, a gum, a flavoring agent, a sweetener, a vitamin, and combinations thereof.

13. The method of claim 11, wherein the at least one optional ingredient comprises one or more of the following: a thickening agent, an emulsifying agent, a stabilizing agent, an aerating agent, a wetting agent, a setting agent, and combinations thereof.

14. The method of claim 5, wherein the cream comprises one of the following: a cream with a milk fat content below 36 percent milk fat; a cream with a milk fat content between 36 and 42 percent milk fat; and a cream with a milk fat content above 42 percent milk fat.

15. An anti-agglomeration yogurt-based product for use in an aerosol container, comprising:
a suspension, wherein the suspension is created by mixing at least one dairy ingredient and water;
pasteurizing the suspension;
cooling the suspension to a temperature range to enable culture activity;
inoculating the suspension with a culture of yogurt-forming bacteria;
homogenizing the suspension; and
packaging the suspension.

16. The product of claim 15, further comprising packaging the suspension in a pressure dispensing aerosol container.

17. The product of claim 15, further comprising, after inoculation, when the suspension pH range is between 4.0 and 4.4, mixing a cream into the suspension.

18. The product of claim 17, further comprising adding lactic acid after mixing the cream into the suspension to maintain a pH range between 4.0 and 4.6.

19. The product of claim 15, further comprising, before the pasteurization, heating the suspension to a temperature range that facilitates homogenizing the suspension and homogenizing the suspension.

20. The product of claim 15, further comprising packaging the suspension with a propellant in a pressure dispensing aerosol container at a pressure from about 120 to about 160 PSI and a shake-time from about 5 to 30 seconds.
